(19) United States
(12) Patent Application Publication
(10) Pub. No.: US 2024/0004665 A1
(43) Pub. Date: Jan. 4, 2024

(54) APPARATUS, SYSTEM, AND METHOD FOR MAKING EFFICIENT PICKS OF MICRO-OPERATIONS FOR EXECUTION

(71) Applicant: Advanced Micro Devices, Inc., Santa Clara, CA (US)

(72) Inventors: Sankaranarayanan Gurumurthy, Austin, TX (US); Christopher J. Burke, Austin, TX (US)

(73) Assignee: Advanced Micro Devices, Inc., Santa Clara, CA (US)

(21) Appl. No.: 17/855,528

(22) Filed: Jun. 30, 2022

(51) Int. Cl. G06F 9/22

(52) U.S. Cl. CPC G06F 9/223

(57) ABSTRACT

A disclosed method for making efficient picks of micro-operations for execution includes selecting a first set of micro-operations that are ready for execution during a certain clock cycle. The method also includes selecting a second set of micro-operations that are ready for execution during the certain clock cycle. The method additionally includes replacing one or more of the complex micro-operations included in the first set of micro-operations with one or more simple micro-operations included in the second set of micro-operations due at least in part to a number of complex micro-operations included in the first set of micro-operations exceeding a set of complex resources capable of executing the complex micro-operations. Various other apparatuses, systems, and methods are also disclosed.

### BACKGROUND

Processors often include a picker responsible for picking groups of micro-operations (commonly referred to as micro-ops) to be fed to execution resources like arithmetic logic units (ALUs), binary multipliers, and/or floating point units (FPUs) for execution. In some examples, ALUs are unable to perform and/or execute certain complex micro-operations (e.g., multiplication and/or division operations). In these examples, binary multipliers and/or FPUs are able to perform and/or execute such complex micro-operations. However, these binary multipliers and/or FPUs can necessitate and/or consume more space and/or real estate than ALUs on such processors. For this reason, manufacturers often opt for and/or prefer processor architectures that include more ALUs than binary multipliers and/or FPUs.

The present disclosure, therefore, identifies and addresses a need for additional and improved apparatuses, systems, and methods for making efficient picks of micro-operations in view of the number of execution resources (e.g., ALUs, binary multipliers, and/or FPUs) included in certain processor architectures.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary processor for making efficient picks of micro-operations for execution according to one or more implementations of this disclosure.

FIG. 2 is a block diagram of an exemplary implementation of certain features that facilitate making efficient picks of micro-operations for execution according to one or more implementations of this disclosure.

FIG. 3 is a block diagram of an exemplary pipeline included in a processor that facilitates making efficient picks of micro-operations for execution according to one or more implementations of this disclosure.

FIG. 4 is a block diagram of an exemplary implementation of certain features that facilitate making efficient picks of micro-operations for execution according to one or more implementations of this disclosure.

FIG. 5 is a block diagram of an exemplary pipeline included in a processor that facilitates making efficient picks of micro-operations for execution according to one or more implementations of this disclosure.

FIG. 6 is a block diagram of an exemplary implementation of a processor that makes efficient picks of micro-operations for execution according to one or more implementations of this disclosure.

FIG. 7 is a block diagram of an exemplary implementation of a processor that makes efficient picks of micro-operations for execution according to one or more implementations of this disclosure.

FIG. 8 is a flowchart of an exemplary method for making efficient picks of micro-operations for execution according to one or more implementations of this disclosure.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION OF EXEMPLARY IMPLEMENTATIONS

The present disclosure describes various apparatuses, systems, and methods for making efficient picks of micro-operations for execution. As will be explained in greater detail below, the various apparatuses, systems, and/or methods described herein can provide various benefits and/or advantages over certain traditional implementations of processors, pipelines, and/or pickers.

In some cases, binary multipliers and/or FPUs perform and/or execute complex micro-operations (e.g., multiplication and/or division operations) that ALUs are unable to perform and/or execute. However, because these binary multipliers and/or FPUs can necessitate and/or consume more space and/or real estate than ALUs on such processors, manufacturers often opt for and/or prefer processor architectures that include more ALUs than binary multipliers and/or FPUs. Unfortunately, if the number of complex micro-operations selected by a picker in a given clock cycle exceeds the number of binary multipliers and/or FPUs in the processor, the excess complex micro-operations are dropped and/or removed from the pick.

For example, if a processor includes 5 ALUs and 1 binary multiplier, a picker in the processor can select 6 micro-operations per clock cycle. However, in this example, if the picker selects more than 1 complex micro-operation in a given clock cycle, the picker is forced to drop all complex micro-operations in excess of 1 due at least in part to the processor only including 1 binary multiplier. This drop can result in an incomplete and/or underutilized pick, thus potentially impairing the processor's performance and/or efficiency.

The various apparatuses, systems, and/or methods described herein address and/or resolve such incomplete and/or underutilized picks and can thus improve the processor's performance and/or efficiency. For example, the various apparatuses, systems, and/or methods described herein can ensure that complex micro-operations (e.g., multiplication and/or division operations) dropped by a picker due to insufficient complex resources in a given clock cycle are replaced by simple micro-operations (e.g., addition, subtraction, and/or comparison operations). By doing so, these apparatuses, systems, and/or methods can avoid issuing incomplete and/or underutilized picks with empty slots, thus potentially improving the performance and/or efficiency of the processor on which the picker is implemented.

In one example, a method for accomplishing such a task includes selecting a first set of micro-operations that are ready for execution during a certain clock cycle. The method also includes selecting a second set of micro-operations that are ready for execution during the certain clock cycle. The method additionally includes replacing one or more of the complex micro-operations included in the first set of micro-operations with one or more simple micro-operations included in the second set of micro-operations due at least in part to a number of complex micro-operations included in the first set of micro-operations exceeding a set of complex resources capable of executing the complex micro-operations.

In one example, the method further includes feeding the first set of micro-operations to the set of complex resources and a set of simple resources via a set of issue ports upon replacing the one or more complex micro-operations with the one or more simple micro-operations in the first set of micro-operations. In one example, the set of complex resources can include one or more binary multipliers and/or one or more FPUs. Additionally or alternatively, the set of simple resources can include one or more ALUs.

In one example, the method also includes selecting the first set of micro-operations from the scheduler queue due at least in part to the first set of micro-operations being older than all the other micro-operations in the scheduler queue during the certain clock cycle. Additionally or alternatively, the method can include selecting the one or more simple micro-operations from the scheduler queue for inclusion in the second set of micro-operations due at least in part to the second set of micro-operations being older than all the other simple micro-operations in the scheduler queue during the certain clock cycle.

In one example, the method also includes identifying the number of complex micro-operations by counting the number of complex micro-operations included in the first set of micro-operations during a subsequent clock cycle. In this example, the method further includes replacing the one or more complex micro-operations included in the first set of micro-operations by calculating a difference between the number of complex micro-operations included in the first set of micro-operations and the number of complex resources capable of executing the complex micro-operations in a processor and then determining that the one or more complex micro-operations included in the first set of micro-operations are sufficient to satisfy the difference between the number of complex micro-operations included in the first set of micro-operations and the number of complex resources and that the one or more complex micro-operations included in the first set of micro-operations are younger than all other complex micro-operations included in the first set of micro-operations.

In one example, the first set of micro-operations can include a combination of complex micro-operations and simple micro-operations. In this example, the second set of micro-operations consists only of simple micro-operations.

In one example, the first set of micro-operations include a number of micro-operations that coincides with a total number of complex resources and simple resources in a processor. In this example, the second set of micro-operations include a number of simple micro-operations that does not exceed a difference between the number of micro-operations and a total number of complex resources in the processor.

In one example, the complex micro-operations can each require multiple clock cycles for execution by a processor. In this example, the simple micro-operations can each require a single clock cycle for execution by the processor.

In one example, the complex micro-operations can each include at least one of a multiplication operation and/or a division operation. In this example, the simple micro-operations can each include at least one of an addition operation, a subtraction operation, and/or a comparison operation.

In one example, the method can also include identifying a set of issue ports that lead to the set of complex resources and a set of simple resources. In this example, the method further includes identifying, within the set of issue ports, one or more issue ports that lead to the set of complex resources. Additionally or alternatively, the method can include rearranging an order of the first set of micro-operations such that all the complex micro-operations included in the first set of micro-operations are fed to the one or more issue ports that lead to the set of complex resources.

In one example, a processor that makes efficient picks of micro-operations for execution includes a first picker configured to select a first set of micro-operations that are ready for execution during a certain clock cycle. The processor also includes a second picker configured to select a second set of micro-operations that are ready for execution during the certain clock cycle. In this example, the first picker or the second picker is configured to replace one or more of the complex micro-operations included in the first set of micro-operations with one or more simple micro-operations included in the second set of micro-operations due at least in part to a number of complex micro-operations included in the first set of micro-operations exceeding a set of complex resources capable of executing the complex micro-operations.

In one example, the first picker is further configured to feed the first set of micro-operations to the set of complex resources and a set of simple resources via a set of issue ports upon replacing the one or more complex micro-operations with the one or more simple micro-operations in the first set of micro-operations. In one example, the set of complex resources can include one or more binary multipliers and/or one or more FPUs. Additionally or alternatively, the set of simple resources can include one or more ALUs.

In one example, the first picker is further configured to select the first set of micro-operations from the scheduler queue due at least in part to the first set of micro-operations being older than all the other micro-operations in the scheduler queue during the certain clock cycle. Additionally or alternatively, the second picker is further configured to select the one or more simple micro-operations from the scheduler queue for inclusion in the second set of micro-operations due at least in part to the second set of micro-operations being older than all the other simple micro-operations in the scheduler queue during the certain clock cycle.

In one example, the first or second picker is further configured to identify the number of complex micro-operations by counting the number of complex micro-operations included in the first set of micro-operations during a subsequent clock cycle. In this example, the first or second picker is further configured to replace the one or more complex micro-operations included in the first set of micro-operations by calculating a difference between the number of complex micro-operations included in the first set of micro-operations and the number of complex resources capable of executing the complex micro-operations in a processor and then determining that the one or more complex micro-operations included in the first set of micro-operations are sufficient to satisfy the difference between the number of complex micro-operations included in the first set of micro-operations and the number of complex resources and that the one or more complex micro-operations included in the first set of micro-operations are younger than all other complex micro-operations included in the first set of micro-operations.

In one example, the first set of micro-operations can include a combination of complex micro-operations and simple micro-operations. In this example, the second set of micro-operations consists only of simple micro-operations.

In one example, the first set of micro-operations include a number of micro-operations that coincides with a total number of complex resources and simple resources in a processor. In this example, the second set of micro-operations include a number of simple micro-operations that does not exceed a difference between the number of micro-operations and a total number of complex resources in the processor.

In some examples, a computing device that makes efficient picks of micro-operations for execution includes a processor and a memory device communicatively coupled to the processor. In one example, the processor is configured to select a first set of micro-operations that are ready for execution during a certain clock cycle. In this example, the processor is configured to select a second set of micro-operations that are ready for execution during the certain clock cycle. The processor is also configured to replace one or more of the complex micro-operations included in the first set of micro-operations with one or more simple micro-operations included in the second set of micro-operations due at least in part to a number of complex micro-operations included in the first set of micro-operations exceeding a set of complex resources capable of executing the complex micro-operations. In one example, the memory device is configured to store one or more computer-readable instructions from which the processor is able to derive the first set of micro-operations and the second set of micro-operations.

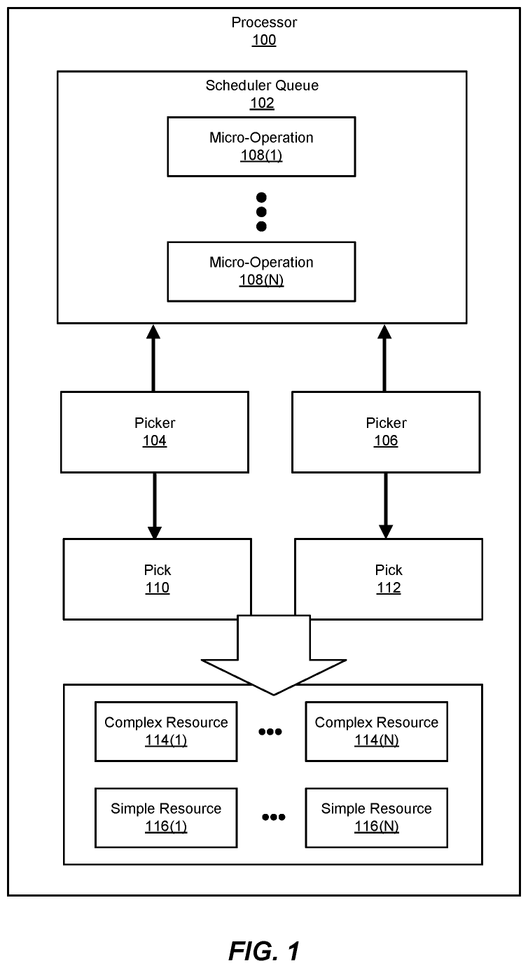

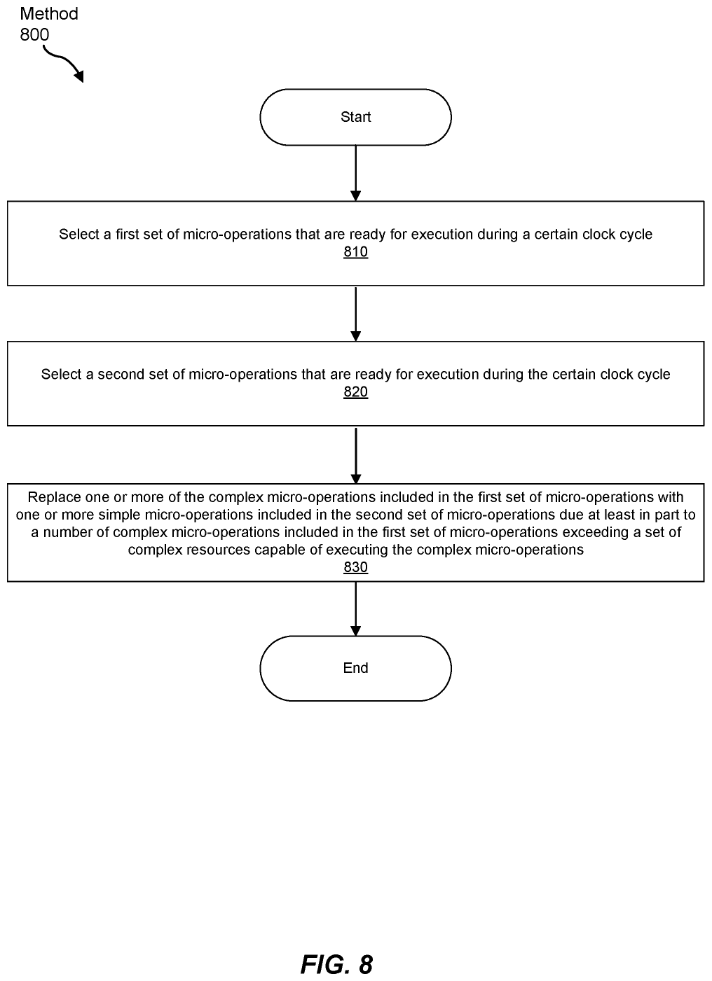

The following will provide, with reference to FIGS. 1-7, detailed descriptions of exemplary apparatuses, systems, and/or corresponding implementations for making efficient picks of micro-operations for execution. Detailed descriptions of an exemplary method for making efficient picks of micro-operations for execution will be provided in connection with FIG. 8.

FIG. 1 shows an exemplary processor 100 that facilitates making efficient picks of micro-operations for execution. As illustrated in FIG. 1, processor 100 includes and/or represents a scheduler queue 102 that maintains, store, and/or buffer micro-operations 108(1)-(N). In some examples, scheduler queue 102 maintains, stores, and/or buffers micro-operations 108(1)-(N) in an age-based order and/or a first in, first out (FIFO) order. Additionally or alternatively, processor 100 includes and/or represents a picker 104 and/or a picker 106 that are responsible for picking and/or selecting groups of micro-operations 108(1)-(N) from scheduler queue 102.

In some examples, processor 100 includes and/or represents a set of one or more complex resources 114(1)-(N) and/or a set of one or more simple resources 116(1)-(N). In one example, complex resources 114(1)-(N) are able to perform, compute, and/or execute complex micro-operations picked and/or selected by picker 104. In this example, simple resources 116(1)-(N) are able to perform, compute, and/or execute simple micro-operations picked and/or selected by picker 104 and/or picker 106.

In some examples, processor 100 can include and/or represent any type or form of hardware-implemented device capable of interpreting and/or executing computer-readable instructions. In one example, processor 100 includes and/or represents one or more semiconductor devices implemented and/or deployed as part of a computing system. Examples of processor 100 include, without limitation, central processing units (CPUs), microprocessors, microcontrollers, field-programmable gate arrays (FPGAs) that implement softcore processors, application-specific integrated circuits (ASICs), systems on a chip (SoCs), portions of one or more of the same, variations or combinations of one or more of the same, and/or any other suitable processor.

Processor 100 can implement and/or be configured with any of a variety of different architectures and/or microarchitectures. For example, processor 100 can implement and/or be configured as a reduced instruction set computer (RISC) architecture. In another example, processor 100 can implement and/or be configured as a complex instruction set computer (CISC) architecture. Additional examples of such architectures and/or microarchitectures include, without limitation, 16-bit computer architectures, 32-bit computer architectures, 64-bit computer architectures, x86 computer architectures, advanced RISC machine (ARM) architectures, microprocessor without interlocked pipelined stages (MIPS) architectures, scalable processor architectures (SPARCs), load-store architectures, portions of one or more of the same, combinations or variations of one or more of the same, and/or any other suitable architectures or microarchitectures.

In some examples, scheduler queue 102 can include and/or represent any type or form of queue and/or buffer implemented and/or configured in processor 100. In one example, scheduler queue 102 can include and/or represent a data structure and/or an abstract data type. In another example, scheduler queue 102 can include and/or represent a feature of a CPU that maintains, presents, and/or provides micro-operations 108(1)-(N) to be picked for issuance to complex resources 114(1)-(N) and/or simple resources 116(1)-(N). Additionally or alternatively, scheduler queue 102 can include and/or represent hardware, software, and/or firmware implemented as part of processor 100.

In some examples, picker 104 and/or picker 106 can include and/or represent any type or form of process, module, and/or unit that picks and/or selects groups of micro-operations 108(1)-(N) for execution by complex resources 114(1)-(N) and/or simple resources 116(1)-(N). In one example, picker 104 is configured to pick and/or select a certain number of micro-operations 108(1)-(N) as a pick 110, and picker 106 is configured to pick and/or select a certain number of micro-operations 108(1)-(N) as a pick 112. For example, picker 104 is configured to pick and/or select simple and/or complex operations, while picker 106 is configured to pick and/or select only simple micro-operations. In certain implementations, picker 104 and/or picker 106 can include and/or represent hardware, software, and/or firmware implemented as part of processor 100.

In some examples, pick 110 includes and/or represents a higher or lower number of micro-operations than pick 112. Additionally or alternatively, pick 110 can include and/or represent any combination of complex and simple micro-operations, whereas pick 112 includes and/or represents exclusively simple micro-operations. In certain scenarios, picks 110 and 112 can share certain overlapping micro-operations in common with one another.

In some examples, pick 110 includes a number of micro-operations that coincides with the total number of complex resources and simple resources in processor 100. In such examples, pick 112 includes a number of simple micro-operations that does not exceed the difference between the number of micro-operations included in pick 110 and the number of complex resources in processor 100. For example, in some pick cycles, pick 110 can include the maximum number of complex micro-operations allowed by processor 100 with the remainder being simple micro-operations. However, in other pick cycles, pick 110 can include all simple micro-operations with no complex micro-operations.

In some examples, complex resources 114(1)-(N) and/or simple resources 116(1)-(N) can include and/or represent any type or form of digital circuit that performs micro-operations on numbers, data, and/or values. In one example, complex resources 114(1)-(N) can include and/or represent binary multipliers and/or FPUs capable of executing complex micro-operations (such as multiplication and/or division operations). Additionally or alternatively, complex resources 114(1)-(N) can each include and/or represent any other type of resource (e.g., a complex ALU) capable of executing such complex micro-operations. In this example, simple resources 116(1)-(N) can include and/or represent ALUs capable of executing simple micro-operations (such as addition, subtraction, and/or comparable operations).

In some examples, micro-operations 108(1)-(N) can include and/or represent any type or form of code and/or instruction performed and/or executed by complex resources 114(1)-(N) and/or simple resources 116(1)-(N) of processor 100. In one example, micro-operations 108(1)-(N) can include and/or represent one or more complex and/or special micro-operations (such as multiplication and/or division operations) that require multiple clock cycles for execution by complex resources 114(1)-(N). Additionally or alternatively, micro-operations 108(1)-(N) can include and/or represent one or more simple and/or general micro-operations (such as addition, subtraction, and/or comparable operations) that require only a single clock cycle for execution by simple resources 116(1)-(N). Micro-operations 108(1)-(N) can also involve and/or represent updates to registers, data transfers to or between registers, and/or data transfers from interfaces (e.g., buses) to registers or vice versa.

In some examples, processor 100 can include and/or incorporate one or more additional components that are not explicitly represented and/or illustrated in FIG. 1. Examples of such additional components include, without limitation, registers, memory devices, circuitry, transistors, resistors, capacitors, diodes, connections, traces, buses, semiconductor (e.g., silicon) devices and/or structures, combinations or variations of one or more of the same, and/or any other suitable components that enable processor 100 to make efficient picks of micro-operations for execution. Additionally or alternatively, processor 100 can exclude and/or omit one or more of the components, devices, and/or features that are illustrated and/or labelled in FIG. 1. For example, processor 100 can exclude and/or omit complex resource 114(N) in pipeline implementations that feature only a single complex resource.

In some examples, picker 104 selects and/or picks a certain number of micro-operations 108(1)-(N) from scheduler queue 102 for inclusion in pick 110. In such examples, the micro-operations selected and/or picked by picker 104 are ready for execution by one or more of complex resources 114(1)-(N) and/or simple resources 116(1)-(N). In one example, picker 104 can select and/or pick the oldest N number of micro-operations of any type and/or kind.

In some examples, picker 106 selects and/or picks a certain number of micro-operations 108(1)-(N) from scheduler queue 102 for inclusion in pick 112. In such examples, the micro-operations selected and/or picked by picker 106 are ready for execution by one or more of simple resources 116(1)-(N). In one example, picker 106 can select and/or pick the oldest M number of micro-operations 108(1)-(N) capable of being executed and/or performed by simple resources 116(1)-(N).

In some examples, the phrase “ready for execution,” as used in this context, can indicate and/or suggest that those micro-operations are free of dependencies and/or contingencies that could potentially alter the state of one or more variables of such micro-operations. In one example, a micro-operation can be considered and/or deemed ready for execution if the state of its variable(s) are not due to change before the micro-operation's execution. For example, a multiplication operation that is ready for execution includes and/or represents one or more variables that are in the proper and/or correct state for execution. In other words, the variables included and/or represented in the multiplication operation are not be subject to change (by way of, e.g., another operation) prior to the execution of the multiplication operation. Put differently, if a specific micro-operation is ready for execution, the variables included and/or represented in that specific micro-operation are not acted upon and/or altered by any other micro-operations until after the execution of that specific micro-operation.

In some examples, picker 104 and/or another component of processor 100 can count and/or identify the number of complex micro-operations that are included in pick 110. In such examples, picker 104 and/or another component of processor 100 can determine that the number of complex micro-operations included in pick 110 exceeds the number of complex resources 114(1)-(N) capable of executing the complex micro-operations in processor 100. In response to this determination, picker 104 and/or another component of processor 100 can replace one or more of the complex micro-operations included in pick 110 with one or more simple micro-operations included in pick 112. In other words, picker 104 and/or another component of processor 100 can substitute one or more simple micro-operations included in pick 112 for one or more of the complex micro-operations included in pick 110. In one example, upon replacing the one or more complex micro-operations with the one or more simple micro-operations in pick 110, picker 104 can feed, push, and/or issue pick 110 down the pipeline of processor 100 for execution by complex resources 114(1)-(N) and/or simple resources 116(1)-(N).

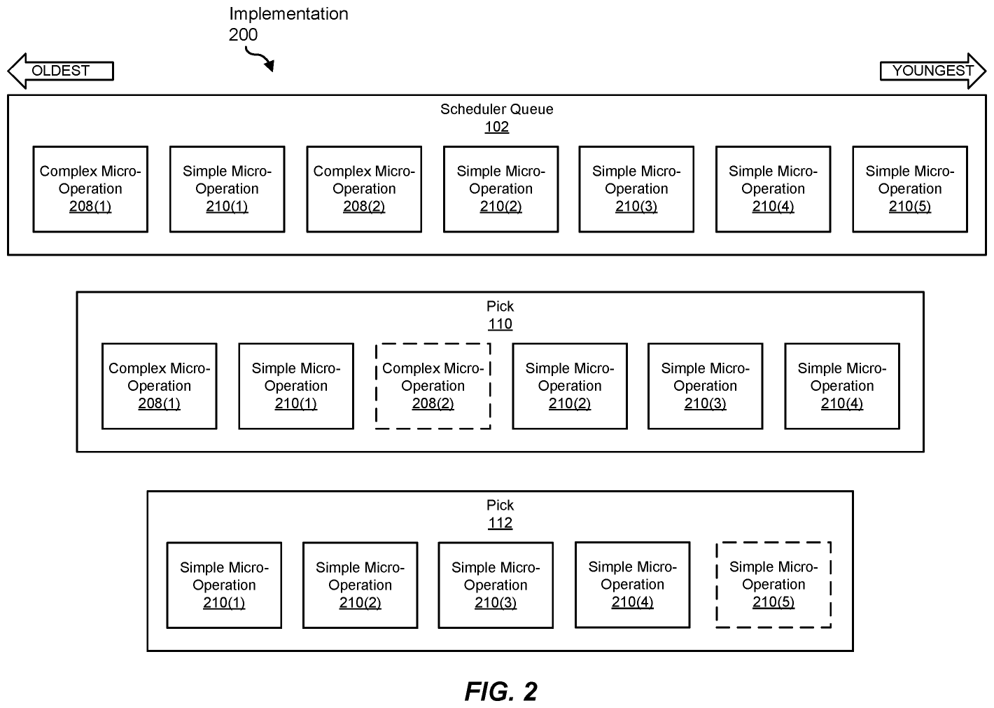

FIG. 2 shows an exemplary implementation 200 of a processor that facilitates making efficient picks of micro-operations for execution. As illustrated in FIG. 2, scheduler queue 102 maintains, stores, and/or loads various simple and complex micro-operations in an age-ordered arrangement. In some examples, the left-side of scheduler queue 102 in FIG. 2 corresponds to and/or represents the oldest of the queued micro-operations, whereas the right side of scheduler queue 102 in FIG. 2 corresponds to and/or represents the youngest of the queued micro-operations. For example, as depicted in FIG. 2, scheduler queue 102 includes and/or represents complex micro-operations 208(1) and 208(2) as well as simple micro-operations 210(1), 210(2), 210(3), 210(4), and 210(5). In this example, complex micro-operation 208(1) is the oldest within scheduler queue 102, and simple micro-operation 210(5) is the youngest within scheduler queue 102.

In some examples, scheduler queue 102 in FIG. 2 can include and/or represent various other micro-operations that are younger than simple micro-operation 210(5) but are omitted and/or excluded from FIG. 2 for the sake of simplicity and/or clarity. Additionally or alternatively, scheduler queue 102 in FIG. 2 can include and/or represent various other micro-operations that are not yet ready for execution and, as a result, are omitted and/or excluded from FIG. 2 for the sake of simplicity and/or clarity.

In some examples, exemplary implementation 200 of the processor includes and/or represents 1 complex resource and 5 simple resources (not necessarily illustrated or labelled in FIG. 2). In one example, picker 104 initially selects complex micro-operations 208(1)-(2) and simple micro-operations 210(1)-(4) as pick 110 because these are the oldest micro-operations ready for execution in scheduler queue 102. In this example, picker 106 initially selects simple micro-operations 210(1)-(5) as pick 112 because these are the oldest simple micro-operations ready for execution in scheduler queue 102. However, because exemplary implementation 200 of the processor includes only 1 complex resource, picker 104 and/or another component of processor 100 can drop and/or remove complex micro-operation 208(2) from pick 110. As a result, complex micro-operation 208(2) remains in scheduler queue 102 and/or is returned to scheduler queue 102 as and/or after pick 110 is issued for execution by the complex resource and the simple resources. Thus, complex micro-operation 208(2) is still be available for selection by picker 104 in a subsequent pick.

In some examples, picker 104 and/or another component of processor 100 fills the slot vacated by complex micro-operation 208(2) in pick 110 with simple micro-operation 210(5). By doing so, picker 104 and/or another component of processor 100 effectively replaces complex micro-operation 208(2) with simple micro-operation 210(5) in pick 110. Picker 104 then issues pick 110 to the complex resource and the simple resources for execution. Upon issuance and/or execution of pick 110, complex micro-operation 208(1) and/or simple micro-operations 210(1)-(5) can broadcast to their dependents and/or associated registers to update the corresponding data and/or values within processor 100.

As a specific example, exemplary implementation 200 of the processor can involve and/or represent a picking scheme that lasts and/or spans 2 clock cycles. In this example, simple micro-operations can have a latency of 1 clock cycle for execution, and complex micro-operations can have a latency of N clock cycles for execution. During the first clock cycle of the 2-cycle picking scheme, picker 104 can initially select complex micro-operations 208(1)-(2) and simple micro-operations 210(1)-(4) as pick 110, and picker 106 can initially select simple micro-operations 210(1)-(5) as pick 112. In the next clock cycle of the 2-cycle picking scheme, picker 104 can drop complex micro-operation 208(2) from pick 110 and/or replace it with simple micro-operation 210(5) from pick 112. Picker 104 can then issue pick 110 to the complex and simple resources for execution. Upon issuance and/or execution of pick 110, simple micro-operations 210(1)-(4) can immediately broadcast to their dependents and/or associated registers to update the corresponding data and/or values within processor 100. However, as simple micro-operation 210(5) replaced complex micro-operation 208(2) in pick 110, simple micro-operation 210(5) can broadcast to its dependents and/or associated registers to update the corresponding data and/or values within processor 100 during the next clock cycle. In addition, as complex micro-operation 208(1) has a latency of N clock cycles, complex micro-operation 208(1) can broadcast to its dependents and/or associated registers to update the corresponding data and/or values within processor 100 after N clock cycles.

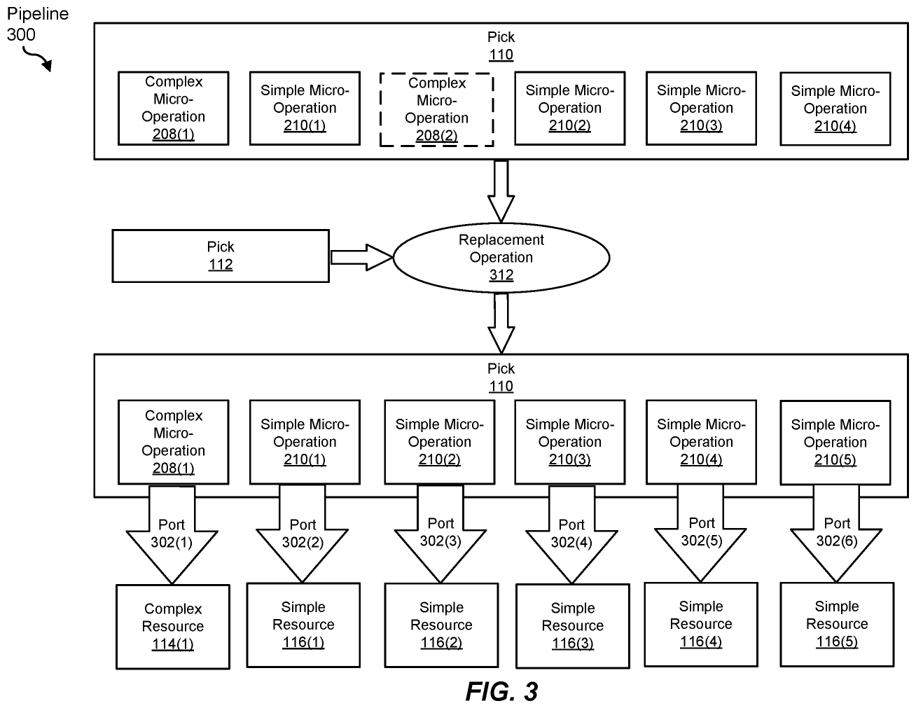

FIG. 3 shows an exemplary pipeline 300 of the processor whose implementation is depicted in FIG. 2. As illustrated in FIG. 3, pipeline 300 of the processor can include and/or involve modifying pick 110 based at least in part on pick 112 via a replacement operation 312. In some examples, upon completion of this modification, pick 110 can issue to complex resource 114(1) and simple resources 116(1)-(5) of the processor via ports 302(1), 302(2), 302(3), 302(4), 302(5), and 302(6), respectively. Accordingly, in this implementation, pipeline 300 can include and/or represent 6 issue slots. In these examples, upon receiving the micro-operations issued in pick 110, complex resource 114(1) and simple resources 116(1)-(5) can perform, compute, and/or execute the micro-operations.

In one example, replacement operation 312 can involve and/or represent picker 104 replacing complex micro-operation 208(2) with simple micro-operation 210(5) in pick 110. Accordingly, prior to replacement operation 312, pick 110 includes and/or represents an initial version and/or composition of pick 110. Conversely, after replacement operation 312, pick 110 includes and/or represents an updated and/or modified version of pick 110. In this example, upon completion of replacement operation 312, picker 104 can direct, dispatch, and/or issue pick 110 by feeding complex micro-operation 208(1) to complex resource 114(1) via port 302(1), simple micro-operation 210(1) to simple resource 116(1) via port 302(2), simple micro-operation 210(2) to simple resource 116(2) via port 302(3), simple micro-operation 210(3) to simple resource 116(3) via port 302(4), simple micro-operation 210(4) to simple resource 116(4) via port 302(5), and/or simple micro-operation 210(5) to simple resource 116(5) via port 302(6).

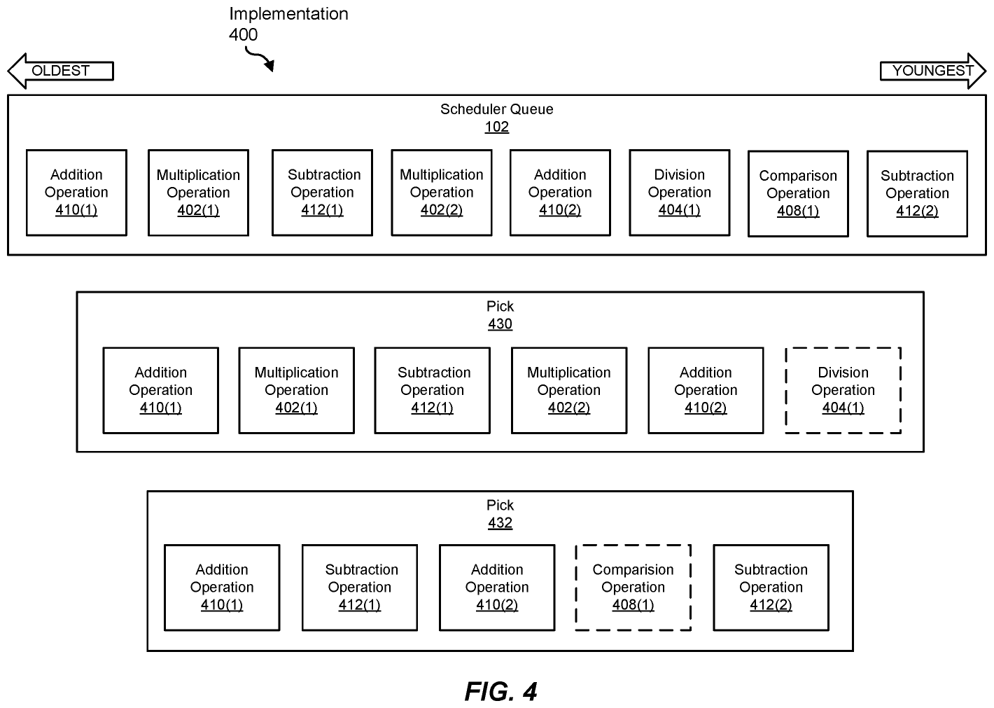

FIG. 4 shows an exemplary implementation 400 of a processor that facilitates making efficient picks of micro-operations for execution. As illustrated in FIG. 4, scheduler queue 102 maintains, stores, and/or loads various simple and complex micro-operations in an age-ordered arrangement. In some examples, as depicted in FIG. 4, scheduler queue 102 includes and/or represents addition operations 410(1) and 410(2), multiplication operations 402(1) and 402(2), subtraction operations 412(1) and 412(2), a division operation 404(1), and/or a comparison operation 408(1). In one example, scheduler queue 102 is ordered by age such that addition operation 410(1) is the oldest micro-operation within scheduler queue 102 and subtraction operation 412(2) is the youngest micro-operation within scheduler queue 102. In addition, scheduler queue 102 in FIG. 4 includes and/or represents various other micro-operations that are younger than simple micro-operation 210(5) but are omitted and/or excluded from FIG. 4 for the sake of simplicity and/or clarity.

In some examples, exemplary implementation 400 of the processor includes and/or represents 2 complex resources and 4 simple resources (not necessarily illustrated or labelled in FIG. 4). In one example, picker 104 initially selects addition operations 410(1)-(2), multiplication operations 402(1)-(2), subtraction operation 412(1), and/or division operation 404(1) as a pick 430. In this example, picker 106 initially selects addition operations 410(1)-(2), subtraction operations 412(1)-(2), and comparison operation 408(1) as a pick 432. However, because exemplary implementation 400 of the processor includes only 2 complex resources, picker 104 and/or another component of processor 100 can drop and/or remove division operation 404(1) from pick 430. As a result, division operation 404(1) remains in scheduler queue 102 and/or be returned to scheduler queue 102 as and/or after pick 430 is issued for execution by the complex resources and the simple resources. Thus, division operation 404(1) is still be available for selection by picker 104 in a subsequent pick.

In some examples, picker 104 and/or another component of processor 100 fills the slots vacated by division operation 404(1) in pick 430 with comparison operation 408(1). By doing so, picker 104 and/or another component of processor 100 can effectively replace division operation 404(1) with comparison operation 408(1) in pick 430. Picker 104 then issues pick 430 to the complex and simple resources for execution. Upon issuance and/or execution of pick 430, addition operations 410(1)-(2), multiplication operations 402(1)-(2), subtraction operation 412(1), and/or comparison operation 408(1) are broadcast to their dependents and/or associated registers to update the corresponding data and/or values within processor 100.

As a specific example, exemplary implementation 400 of the processor can involve and/or represent a picking scheme that lasts and/or spans 2 clock cycles. In this example, addition operations 410(1)-(2), subtraction operations 412(1), and comparison operation 408(1) can each have a latency of 1 clock cycle, and multiplication operations 402(1)-(2) can each have a latency of N clock cycles. During the first clock cycle of the 2-cycle picking scheme, picker 104 initially selects addition operations 410(1)-(2), multiplication operations 402(1)-(2), subtraction operation 412(1), and/or division operation 404(1) as pick 430, and picker 106 initially selects addition operations 410(1)-(2), subtraction operations 412(1)-(2), and comparison operation 408(1) as pick 432. In the next clock cycle of the 2-cycle picking scheme, picker 104 drops division operation 404(1) from pick 430 and/or replaces it with comparison operation 408(1) from pick 432. Picker 104 then issues pick 430 to the complex and simple resources for execution. Upon issuance and/or execution of pick 430, addition operations 410(1)-(2) and/or subtraction operation 412(1) can be immediately broadcast to their dependents and/or associated registers to update the corresponding data and/or values within processor 100. However, as comparison operation 408(1) replaced division operation 404(1) in pick 430, comparison operation 408(1) is broadcast to its dependents and/or associated registers to update the corresponding data and/or values within processor 100 during the next clock cycle. In addition, as multiplication operations 402(1)-(2) each have a latency of N clock cycles, multiplication operations 402(1)-(2) are broadcast to their dependents and/or associated registers to update the corresponding data and/or values within processor 100 after N clock cycles.

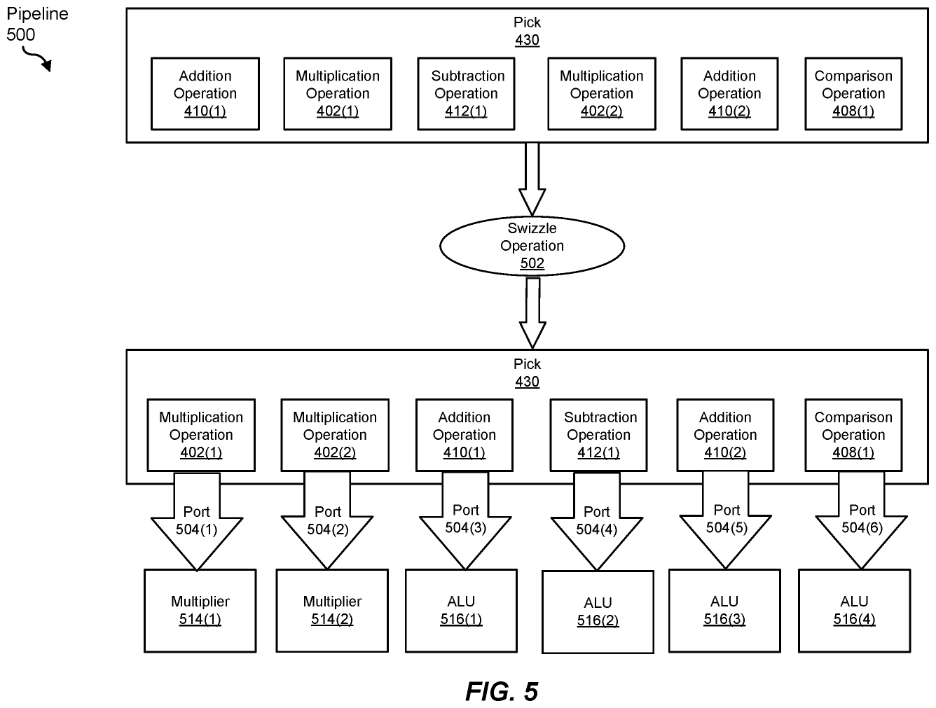

FIG. 5 shows an exemplary pipeline 500 of the processor whose implementation is depicted in FIG. 4. As illustrated in FIG. 5, pipeline 500 of the processor can include and/or involve modifying pick 430 via a swizzle operation 502. In some examples, upon completion of this modification, pick 430 issues to multipliers 514(1) and 514(2) and/or ALUs 516(1), 516(2), 516(3), and 516(4) of the processor via ports 504(1), 504(2), 504(3), 504(4), 504(5), and 504(6), respectively. Accordingly, in this implementation, pipeline 500 includes and/or represents 6 issue slots. In these examples, upon receiving the micro-operations issued in pick 430, multipliers 514(1)-(2) and/or ALUs 516(1)-(4) perform, compute, and/or execute those micro-operations.

In one example, swizzle operation 502 involves and/or represents picker 104 rearranging and/or reordering addition operations 410(1)-(2), multiplication operations 402(1)-(2), subtraction operation 412(1), and/or comparison operation 408(1) in pick 110. For example, each micro-operation included in pick 430 corresponds to and/or is assigned to one of the 6 issue slots. In this example, as part of swizzle operation 502, picker 104 rearranges and/or reorders pick 430 relative to the 6 issue slots such that multiplication operations 402(1)-(2) align with and/or are directed toward multipliers 514(1)-(2), respectively. Additionally or alternatively, picker 104 rearranges and/or reorders pick 430 relative to the 6 issue slots such that addition operation 410(1), subtraction operation 412(1), addition operation 410(2), and/or comparison operation 408(1) are aligned with and/or are directed toward ALUs 516(1)-(4), respectively. After completion of swizzle operation 502, picker 104 issues and/or feeds multiplication operations 402(1)-(2) to multipliers 514(1)-(2) via ports 504(1)-(2), and/or picker 104 issues and/or feeds addition operation 410(1), subtraction operation 412(1), addition operation 410(2), and/or comparison operation 408(1) to ALUs 516(1)-(4) via ports 504(3)-(6).

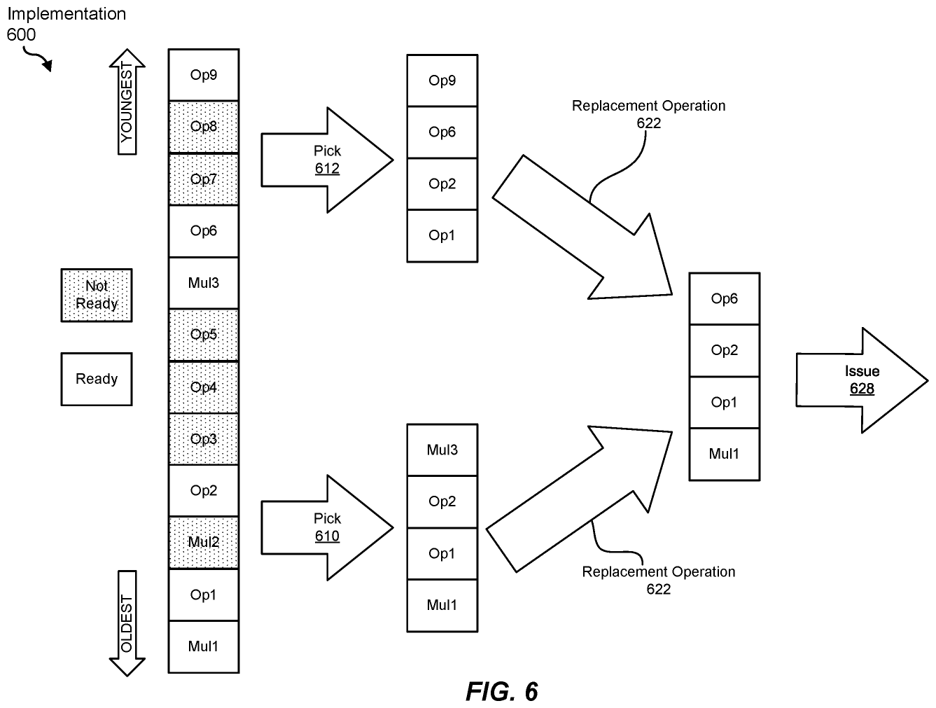

FIG. 6 shows an exemplary implementation 600 of a processor that facilitates making efficient picks of micro-operations for execution. As illustrated in FIG. 6, exemplary implementation 600 includes and/or represents various micro-operations maintained, stored, and/or loaded into a scheduler queue in an age-ordered arrangement. For example, such micro-operations include and/or represent Mul1, Op1, Mul2, Op2, Op3, Op4, Op5, Mul3, Op6, Op7, Op8, and/or Op9 within the scheduler queue. In this example, Mul 1 is the oldest micro-operation within the scheduler queue, and Op9 is the youngest micro-operation within the scheduler queue.

In some examples, various micro-operations (e.g., Mul1, Op1, Op2, Mul3, Op6, and/or Op9) loaded into the scheduler queue are ready for execution, while various other micro-operations (e.g., Mul2, Op3, Op4, Op5, Op7, and/or Op8) are not yet ready for execution. As a result of not yet being ready for execution, those other micro-operations are unavailable for selection by picker 104 and/or picker 106 until a subsequent clock cycle. In one example, picker 104 selects Mul1, Op1, Op2, and/or Mul3 as a pick 610. In this example, picker 106 selects Op1, Op2, Op6, and/or Op9 as a pick 612.

In implementation 600, the pipeline of the processor includes and/or represents an execution unit with 1 complex resource (e.g., a multiplier) and/or 3 simple resources (e.g., ALUs). In pick 610, Mul1 and/or Mul3 constitute and/or represent multiplication operations, and Op1 and Op2 constitute and/or represent simple micro-operations (e.g., addition, subtraction, and/or comparison operations). In contrast, all the micro-operations included in pick 612 constitute and/or represent simple micro-operations.

In some examples, as the pipeline of the processor includes only 1 complex resource, picker 104 and/or another component of the processor counts the number of multiplication operations in pick 610 and then determines that pick 610 includes 1 multiplication operation in excess of the number of complex resources. As a result, picker 104 and/or the other component of the processor can perform a replacement operation 622 by dropping and/or removing Mul3 from pick 610 and then adding Op6 from pick 612 to pick 610. By doing so, picker 104 and/or the other component of the processor can ensure that all the issue slots available for execution within the pipeline of the processor are utilized, thereby improving efficiency and/or performance of the processor. Upon completion of replacement operation 622, the final pick consisting of Mul1, Op1, Op2, and/or Op6 is fed to the complex and/or simple resources for execution as an issue 628.

In some examples, the picking scheme depicted in implementation 600 involves and/or represents 4 micro-operations picked per clock cycle and/or 4 micro-operations issued per clock cycle. In one example, the picking scheme depicted in implementation 600 allows and/or facilitates the selection of 1 multiplication operation per clock cycle. In this example, the selection of picks 610 and 612 and the performance of replacement operation 622 collectively last and/or consume 2 clock cycles. Continuing with this example, the introduction of replacement operation 622 uses and/or takes advantage of a % cycle that existed and/or was available in the 2 clock cycles of the picking scheme.

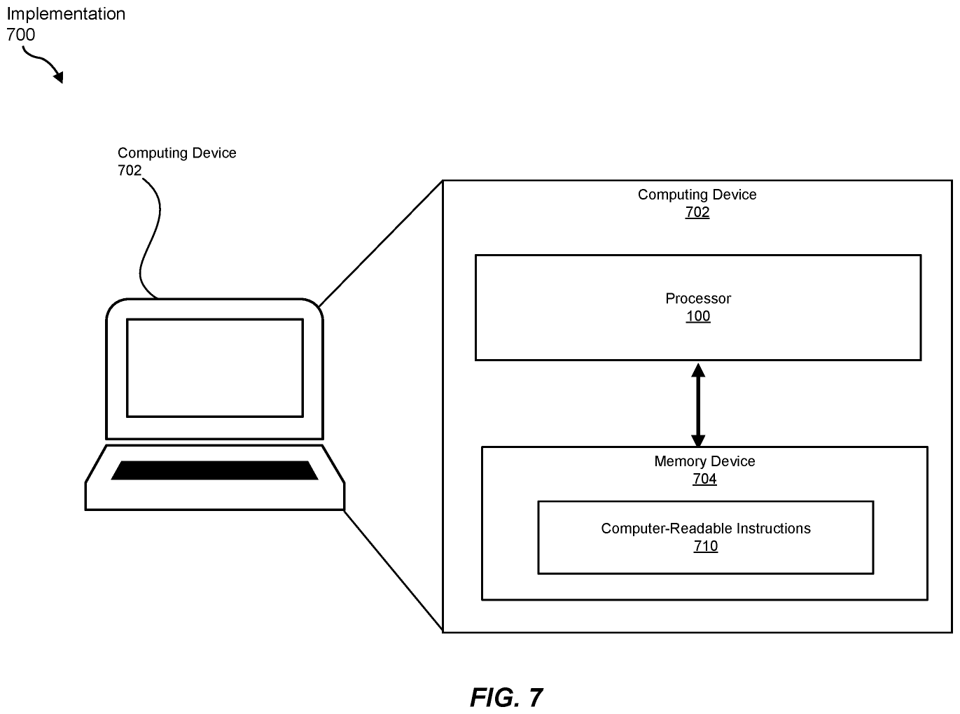

FIG. 7 illustrates an exemplary implementation 700 involving a computing device 702. As illustrated in FIG. 7, computing device 702 includes and/or represents processor 100 communicatively coupled to a memory device 704. In some examples, memory device 704 maintains and/or stores one or more computer-readable instructions 710. In such examples, processor 100 of computing device 702 derives certain micro-operations (including any of those described above in connection with FIGS. 1-6) from computer-readable instructions 710 in memory device 704. For example, processor 100 of computing device 702 can decode computer-readable instructions 710 to produce and/or generate certain micro-operations, which are subsequently performed, computed, and/or executed by complex resources 114(1)-(N) and/or simple resources 116(1)-(N).

In some examples, computing device 702 can include and/or represent any type or form of computer capable of performing computing tasks and/or communicating with other computers. Examples of computing device 702 include, without limitation, client devices, laptops, tablets, desktops, servers, cellular phones, Personal Digital Assistants (PDAs), multimedia players, embedded systems, wearable devices, gaming consoles, routers, switches, hubs, modems, bridges, repeaters, gateways (such as Broadband Network Gateways (BNGs)), multiplexers, network adapters, network interfaces, linecards, portions of one or more of the same, variations or combinations of one or more of the same, and/or any other suitable computing devices.

In some examples, memory device 704 includes and/or represents any type or form of volatile or non-volatile storage device or medium capable of storing data and/or computer-readable instructions. Examples of memory device 704 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable memory device.

FIG. 8 is a flow diagram of an exemplary method 800 for making efficient picks of micro-operations for execution. In one example, the steps shown in FIG. 8 can be performed by one or more components of a processor incorporated into a computing device. Additionally or alternatively, the steps shown in FIG. 8 can also incorporate and/or involve various sub-steps and/or variations consistent with the descriptions provided above in connection with FIGS. 1-7.

As illustrated in FIG. 8, method 800 includes and/or involves the step of selecting a first set of micro-operations that are ready for execution during a certain clock cycle (810). Step 810 can be performed in a variety of ways, including any of those described above in connection with FIGS. 1-7. For example, a main picker included in a processor selects, from a scheduler queue included in the processor, a first set of micro-operations that are ready for execution by a set of complex resources or a set of simple resources during a certain clock cycle.

Method 800 also includes the step of selecting a second set of micro-operations that are ready for execution during the certain clock cycle (820). Step 820 can be performed in a variety of ways, including any of those described above in connection with FIGS. 1-7. For example, a substitute picker included in the processor selects, from the scheduler queue, a second set of micro-operations that are ready for execution by the set of simple resources during the certain clock cycle. In one example, the second set of micro-operations are smaller (e.g., contain fewer micro-operations) than the first set of micro-operations.

Method 800 further includes the step of replacing one or more of the complex micro-operations included in the first set of micro-operations with one or more simple micro-operations included in the second set of micro-operations due at least in part to a number of complex micro-operations included in the first set of micro-operations exceeding a set of complex resources capable of executing the complex micro-operations (830). Step 830 can be performed in a variety of ways, including any of those described above in connection with FIGS. 1-7. For example, the main picker replaces one or more of the complex micro-operations included in the first set of micro-operations with one or more simple micro-operations included in the second set of micro-operations due at least in part to a number of complex micro-operations included in the first set of micro-operations exceeding a set of complex resources capable of executing the complex micro-operations.

As described above in connection with FIGS. 1-8, an exemplary processor includes a main picker capable of selecting ready micro-operations of any type (including both single-cycle and multi-cycle operations) queued by a scheduler and/or a substitute picker capable of selecting only ready single-cycle operations queued in the scheduler. In some examples, the execution unit of the processor includes M special resources (e.g., multipliers and/or FPUs) capable of performing special micro-operations (e.g., multiply, divide, etc.) that require multiple clock cycles as well as general resources (e.g., general ALUs) capable of performing general micro-operations (e.g., add, subtract, compare, etc.) that require only a single clock cycle. In such examples, the main picker has capacity to select N micro-operations per clock cycle (where M<N), and the substitute picker has capacity to select N-M micro-operations per clock cycle. In one example, the main picker selects the N oldest ready micro-operations of any type during a certain clock cycle, and the substitute picker selects the N-M oldest ready general single-cycle micro-operations during that clock cycle. In the next clock cycle, the main picker drops all special operations above M from its pick and replaces them with one or more of the general micro-operations selected by the substitute picker. The main picker and/or another component of the processor then feeds, pushes, and/or issues the resulting mix of special and general micro-operations found in its final pick down the pipeline to the special and general resources via certain issue ports. The special and general resources then execute those operations in due course (e.g., after two or three clock cycles) to carry out one or more computing tasks.

While the foregoing disclosure sets forth various embodiments using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The apparatuses, systems, and methods described herein can employ any number of software, firmware, and/or hardware configurations. For example, one or more of the exemplary embodiments and/or implementations disclosed herein can be encoded as a computer program (also referred to as computer software, software applications, computer-readable instructions, and/or computer control logic) on a computer-readable medium. The term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives and floppy disks), optical-storage media (e.g., Compact Disks (CDs) and Digital Video Disks (DVDs)), electronic-storage media (e.g., solid-state drives and flash media), and/or other distribution systems.

In addition, one or more of the modules, instructions, and/or micro-operations described herein can transform data, physical devices, and/or representations of physical devices from one form to another. Additionally or alternatively, one or more of the modules, instructions, and/or micro-operations described herein can transform a processor, volatile memory, non-volatile memory, and/or any other portion of a physical computing device from one form to another by executing on the computing device, storing data on the computing device, and/or otherwise interacting with the computing device.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A method comprising:
selecting a first set of micro-operations that are ready for execution during a certain clock cycle;
selecting a second set of micro-operations that are ready for execution during the certain clock cycle; and
replacing one or more complex micro-operations included in the first set of micro-operations with one or more simple micro-operations included in the second set of micro-operations due at least in part to the number of complex micro-operations included in the first set of micro-operations exceeding a set of complex resources capable of executing the complex micro-operations, wherein the complex micro-operations each require multiple clock cycles for execution by a processor and the simple micro-operations each require a single clock cycle for execution by the processor.

2. The method of claim 1, further comprising, upon replacing the one or more complex micro-operations with the one or more simple micro-operations in the first set of micro-operations, feeding the first set of micro-operations to the set of complex resources and a set of simple resources via a set of issue ports.

3. The method of claim 2, wherein:
the set of complex resources comprises at least one of:
one or more binary multipliers; or
one or more floating point units; and
the set of simple resources comprises one or more arithmetic logic units.

4. The method of claim 1, wherein selecting the first set of micro-operations comprises selecting the first set of micro-operations from a scheduler queue due at least in part to the first set of micro-operations being older than all other micro-operations that are ready for execution in the scheduler queue during the certain clock cycle.

5. The method of claim 1, wherein selecting the second set of micro-operations comprises selecting the one or more simple micro-operations from a scheduler queue for inclusion in the second set of micro-operations due at least in part to the second set of micro-operations being older than all other simple micro-operations that are ready for execution in the scheduler queue during the certain clock cycle.

6. The method of claim 1, further comprising identifying the number of complex micro-operations by counting the number of complex micro-operations included in the first set of micro-operations during a subsequent clock cycle; and
wherein replacing the one or more complex micro-operations included in the first set of micro-operations with the one or more simple micro-operations comprises:
calculating a difference between the number of complex micro-operations included in the first set of micro-operations and the number of complex resources capable of executing the complex micro-operations in a processor; and
determining that the one or more complex micro-operations included in the first set of micro-operations:
are sufficient to satisfy the difference between the number of complex micro-operations included in the first set of micro-operations and the number of complex resources; and
are younger than all other complex micro-operations included in the first set of micro-operations.

7. The method of claim 1, wherein:
the first set of micro-operations comprises a combination of complex micro-operations and simple micro-operations; and
the second set of micro-operations consists only of simple micro-operations.

8. The method of claim 1, wherein:
the first set of micro-operations comprises a number of micro-operations that coincides with a total number of complex resources and simple resources in a processor; and
the second set of micro-operations comprises a number of simple micro-operations that does not exceed a difference between the number of micro-operations and a total number of complex resources in the processor.

9. (canceled)

10. The method of claim 1, wherein:
the one or more complex micro-operations each comprise at least one of:
a multiplication operation; or
a division operation; and
the one or more simple micro-operations each comprise at least one of:
an addition operation;
a subtraction operation; or
a comparison operation.

11. The method of claim 1, further comprising:
identifying a set of issue ports that lead to the set of complex resources and a set of simple resources;
identifying, within the set of issue ports, one or more issue ports that lead to the set of complex resources; and
rearranging an order of the first set of micro-operations such that all the complex micro-operations included in the first set of micro-operations are fed to the one or more issue ports that lead to the set of complex resources.

12. A processor comprising:
a first picker circuit configured to select a first set of micro-operations that are ready for execution during a certain clock cycle; and
a second picker circuit configured to select a second set of micro-operations that are ready for execution during the certain clock cycle; and
wherein the first picker circuit or the second picker circuit is further configured to replace one or more complex micro-operations included in the first set of micro-operations with one or more simple micro-operations included in the second set of micro-operations due at least in part to the number of complex micro-operations included in the first set of micro-operations exceeding a set of complex resources capable of executing the complex micro-operations the complex micro-operations each requiring multiple clock cycles for execution by a processor and the simple micro-operations each requiring a single clock cycle for execution by the processor.

13. The processor of claim 12, wherein the first picker circuit is further configured to feed, upon replacing the one or more complex micro-operations with the one or more simple micro-operations, the first set of micro-operations to the set of complex resources and a set of simple resources via a set of issue ports.

14. The processor of claim 13, wherein:
the set of complex resources comprises at least one of:
one or more binary multipliers; or
one or more floating point units; and
the set of simple resources comprises one or more arithmetic logic units.

15. The processor of claim 12, wherein the first picker circuit is further configured to select the first set of micro-operations from a scheduler queue due at least in part to the first set of micro-operations being older than all other micro-operations in the scheduler queue during the certain clock cycle.

16. The processor of claim 12, wherein the second picker circuit is further configured to select the one or more simple micro-operations from a scheduler queue for inclusion in the second set of micro-operations due at least in part to the second set of micro-operations being older than all other simple micro-operations in the scheduler queue during the certain clock cycle.

17. The processor of claim 12, wherein the first picker circuit or the second picker circuit is further configured to:
identify the number of complex micro-operations by counting the number of complex micro-operations included in the first set of micro-operations during a subsequent clock cycle; and
replace the one or more complex micro-operations included in the first set of micro-operations with the one or more simple micro-operations by:
calculating a difference between the number of complex micro-operations included in the first set of micro-operations and the number of complex resources capable of executing the complex micro-operations in the processor; and
determining that the one or more complex micro-operations included in the first set of micro-operations:
are sufficient to satisfy the difference between the number of complex micro-operations included in the first set of micro-operations and the number of complex resources; and
are younger than all other complex micro-operations included in the first set of micro-operations.

18. The processor of claim 12, wherein:
the first set of micro-operations comprises a combination of complex micro-operations and simple micro-operations; and
the second set of micro-operations consists only of simple micro-operations.

19. The processor of claim 12, wherein:
the first set of micro-operations comprises a number of micro-operations that coincides with a total number of complex resources and simple resources in the processor; and
the second set of micro-operations comprises a number of simple micro-operations that does not exceed a difference between the number of micro-operations and a total number of complex resources in the processor.

20. A computing device comprising:
a processor configured to:
select a first set of micro-operations that are ready for execution during a certain clock cycle;
select a second set of micro-operations that are ready for execution during the certain clock cycle; and
replace one or more complex micro-operations included in the first set of micro-operations with one or more simple micro-operations included in the second set of micro-operations due at least in part to a number of complex micro-operations included in the first set of micro-operations exceeding a set of complex resources capable of executing the complex micro-operations, wherein the complex micro-operations each require multiple clock cycles for execution by a processor and the simple micro-operations each require a single clock cycle for execution by the processor; and
a memory communicatively coupled to the processor and configured to store one or more computer-readable instructions from which the processor is able to derive the first set of micro-operations and the second set of micro-operations.
